(19) United States
(12) Patent Application Publication
(10) Pub. No.: US 2014/0131370 A1
(43) Pub. Date: May 15, 2014

(54) Ergonomic Vented Waste Container Apparatus

(71) Applicant: Brett Self, Birmingham, AL (US)

(72) Inventor: Brett Self, Birmingham, AL (US)

(21) Appl. No.: 13/673,858

(22) Filed: Nov. 9, 2012

(51) Int. Cl. B65F 1/12

(52) U.S. Cl. CPC B65F 1/12
USPC 220/676

(57) ABSTRACT

An ergonomic vented waste container apparatus comprising a continuous substantially vertical side with a front, left, right and rear surface of the side wall, one or more vertical vents and a left foot well with a bottom foot surface, right surface, rear surface and an upper surface whereby the bottom foot surface forms an acute angle with the right surface and rear surface and an obtuse angle formed between the junction of the upper surface and the right and rear surfaces, and a right foot well with a bottom foot surface, left surface, rear surface and whereby the bottom foot surface forms an acute angle with the left surface and rear surface and an obtuse angle formed between the upper surface of the right foot well and the left and rear surface. The apparatus is provided with protruding knobs and traction pads on the foot well surfaces.

### CROSS-REFERENCE TO RELATED APPLICATION

This application claims priority to U.S. Provisional Application No. 61/558,921 filed Nov. 11, 2011, the disclosure of which is incorporated herein by reference.

### FIELD OF THE INVENTION

The present invention relates to waste containers, and more particularly to a waste container that allows safe removal of a trash liner by providing vents and specially designed foot wells.

### BACKGROUND OF THE INVENTION

The removal of a plastic trash liner full of waste can prove difficult for a number of reasons including the weight of the bag and its contents, the tendency for a trash liner to create a vacuum in the bottom of the container, and the inability to adequately secure the trash can to the ground while lifting the liner. There exist trash cans that provide for vacuum release vents, but they do not provide for increased vacuum release as an operator encounters less leverage in the lifting motion. Another problem observed is that removal of a trash liner can cause injury to the operator because of the lack of pre-determined ergonomically placed bracing foot wells. Competing designs provide for some level of foot bracing, but they are not adequately placed or contemplate for the safe removal of a trash liner. Further, the bracing foot wells that exist in competing designs are not designed to achieve and do not contemplate proper nesting of an operator's foot to avoid slipping out and causing injury. An additional problem with existing waste containers is that they are expensive to manufacture given the complexity of their design. Another problem with existing waste containers is the vacuum release means employed by those designs create sanitary issues with leaked liquids and are difficult to clean. Further disadvantages of other waste containers are that they cannot be easily transported or stored because of their inability to nest. What is needed is a waste container that solves the aforesaid problems.

### SUMMARY OF THE INVENTION

The current invention is a waste container that is ergonomically safe, allows for vacuum release that is incrementally greater as an operator's leverage decreases in the upward lifting motion, is inexpensive to manufacture, easy to clean and dissuades bacterial growth and can be easily transported or stored in high numbers.

The multitude of competing designs do not contemplate all of the features shown herein. Because of its simple but effective design, the current invention is to be made using the process of blow molding—a much cheaper process than injection molding that many of the competing waste containers use. The more complex the waste can design, the more unlikely that the blow molding process will be an option simply from technical limitations of that process. Additionally, the waste container is a single piece having no moving parts for a user to install or have malfunction.

Generally, the waste container comprises a continuous substantially vertical side wall with a bottom which creates the container. Foot wells and vertical vents are also significant features of the invention. The waste container in a preferred embodiment, and as illustrated, is generally rectangular or trapezoidal in shape, but other shapes may be employed.

The current invention is designed to provide for optimal ergonomic safety in the lifting of a loaded trash liner out of a waste container. To achieve this, the current invention in a preferred embodiment has two bracing foot wells located on the front surface of a waste container. Specifically, they are located on the bottom left corner and the bottom right corner of the front surface of the side wall on the waste container. The location of the foot wells forces an operator to evenly space their feet apart at shoulder width. Other designs allow an operator to place their feet wherever they choose, or dictate that they should straddle the trash can diagonally, or use one central foot well in the middle of the waste container. All of these foot placements can increase the risk of injury to an operator and are not ergonomically optimal. The foot wells in the current invention allow for an operator's foot to be placed inside each respective foot well. This allows the operator to use their own body weight to hold the waste container to the ground during lifting. Proper lifting technique by an operator should be to place the left and right foot into their respective foot wells, slightly bend the knees, grasp the trash liner with two hands and gently but steadily begin to pull up on the trash liner until the trash liner clears the lip of the waste container.

The inherent characteristics of the foot well design provides for ergonomic safety in lifting a trash liner out of a waste container. Each foot well has a bottom foot surface, an upper surface, a rear surface and a left side surface for the right foot well and a right side surface for the left foot well. The bottom foot surface has a traction pad that allows for friction between the traction pad and an operator's foot. The traction pad can be made of any material that has frictional properties such as rubber, sandpaper, or fabric. Additionally, the traction pad can have parallel ridges to provide additional traction for an operator's foot.

The angles at which the bottom foot surface meets the rear surface and the left or right side surface further allows for proper nesting of the foot in the foot well and ergonomic safety. The downward force of an operator's foot on the bottom foot surface in the foot well allows for secure placement of the foot and waste container stability. So also does contact of the rear surface and left or right side surface with the foot due to the acute angle formed at the junction of the bottom surface and the rear and left or right side surface. This acute angle allows the rear and left or right side surface of the foot well to quickly come in contact with the side of an operator's foot. The same applies with respect to the angle between the upper surface and rear surface and left or right side surface which is obtuse. This obtuse angle quickly brings the rear and left or right side surface in contact with the top of an operator's foot.

The foot wells are further ergonomically enhanced by employing protruding knobs on the rear surface as well as on the left or right side surface of the foot wells. The knobs can be rectangular, cylindrical, triangular, or odd-shaped and can include continuous manifestations of the shaped knobs that form ridges. The knobs further allow for quick contact with the operator's foot and provide a location, in addition to the bottom foot surface, for the foot to gain traction and stability while lifting a trash liner out of a waste container.

Lifting a trash liner is ideally done with two hands, but often enough one hand has to pull harder thereby creating instability and uneven upward force on the bag. This can cause the trash container to slip or move in one direction and create strain on the operator's back, shoulders, arms and/or legs. The inherent shape of the foot well, the traction pads, and the protruding knobs all work in concert and individually to provide traction and stability of an operator's foot.

The current invention also provides for vertical vents located on the continuous side wall. The vertical vents are an improvement over circular vents used in competing designs in that they do not suffer from air drag caused by the vortex effect inherent in circular apertures. In addition, the vertical vents start at a lower position and extend upwards to a higher position which allows for increased vacuum release as the trash liner is lifted out of the waste container. Because an operator has more leverage in the initial phases of lifting a trash liner out of a waste container, it becomes more difficult to clear the lip of the waste container. The design of the vertical vents allows for increased air flow and vacuum release the higher the trash liner is lifted thereby alleviating the decrease in leverage by the operator. In addition, the bottom position of the vertical vents allows enough room for storage of a substantial amount of leakage should the trash liner fail while in the waste container thereby avoiding unclean conditions on the floor.

The current invention is easy to clean and does not promote conditions for bacterial growth by having a limited amount of surfaces within the interior. Competing waste containers have multiple orifices, diaphragms, and other hard to reach interior surfaces that are a burden to clean and keep clean.

The current invention allows multiple waste containers to be stacked one upon another for efficient transport and storage. This is achievable due to the smaller outer diameter of the bottom compared to the top. Additionally, the foot wells are located in the interior of the waste container thereby keeping them from disturbing the outer surface of the waste container.

### BRIEF DESCRIPTION OF THE DRAWINGS

FIG. 1 is a perspective view of the waste container.

FIG. 2 is a front elevation of the waste container.

FIG. 3 is a rear elevation of the waste container,

FIG. 4 is bottom plan view of the waste container.

FIG. 5 is a right elevation of the waste container.

FIG. 6 is a left elevation of the waste container.

FIG. 7 is an exploded left elevation of the left foot well.

FIG. 8 is an exploded right elevation of the right foot well.

FIG. 9 is a top plan view of the waste container.

### DETAILED DESCRIPTION OF THE INVENTION

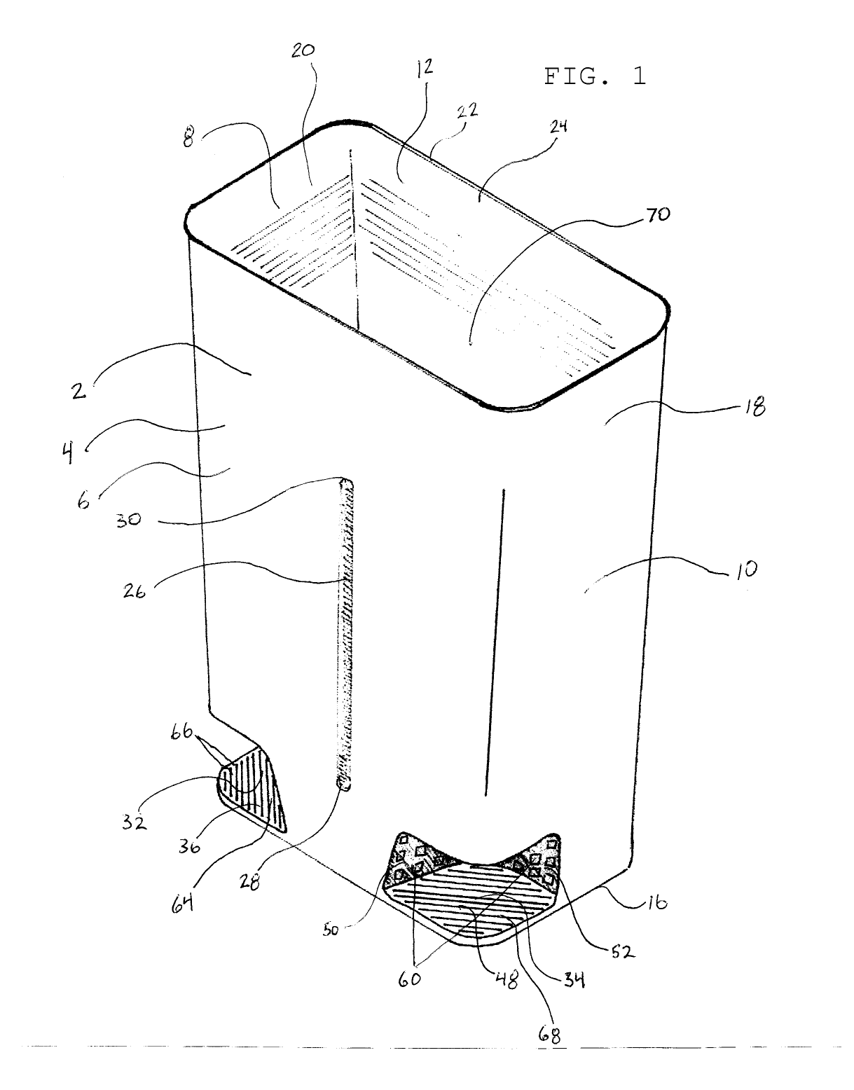

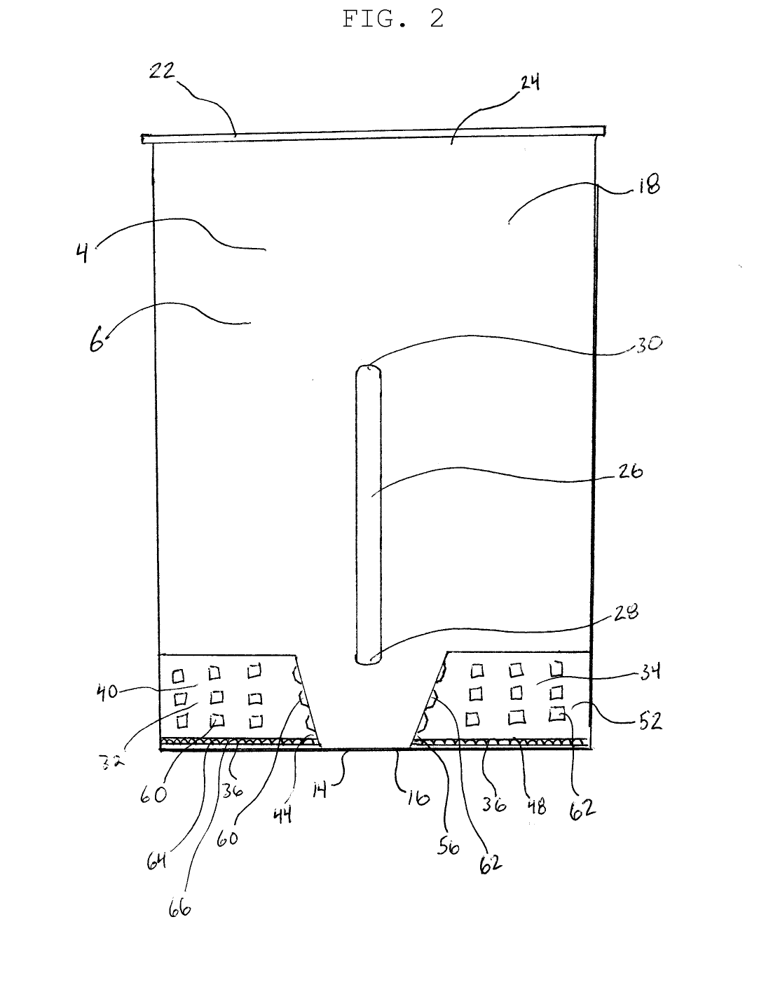

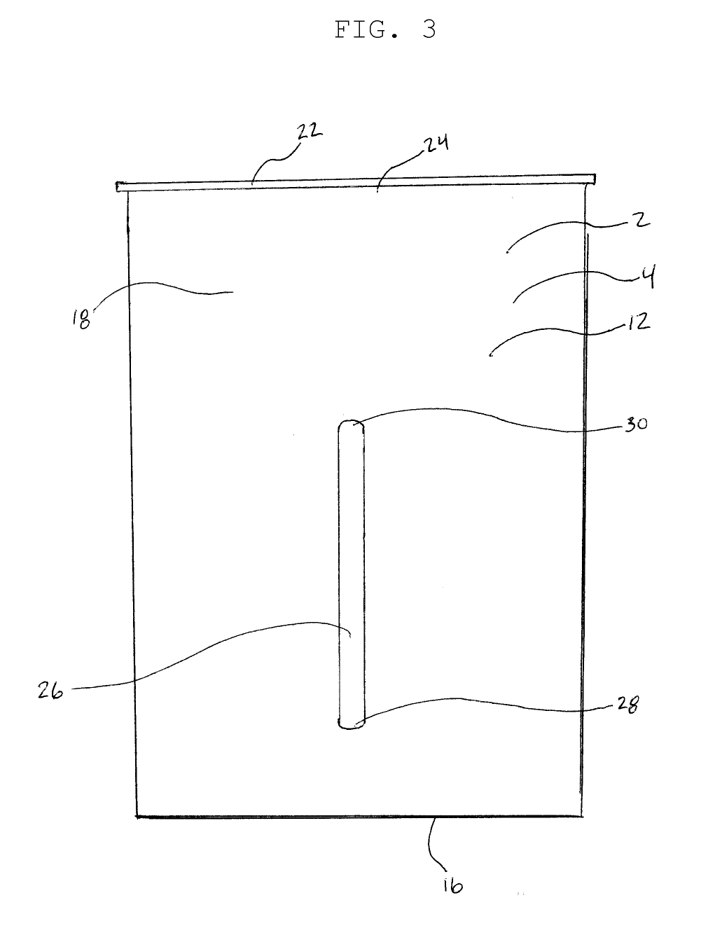

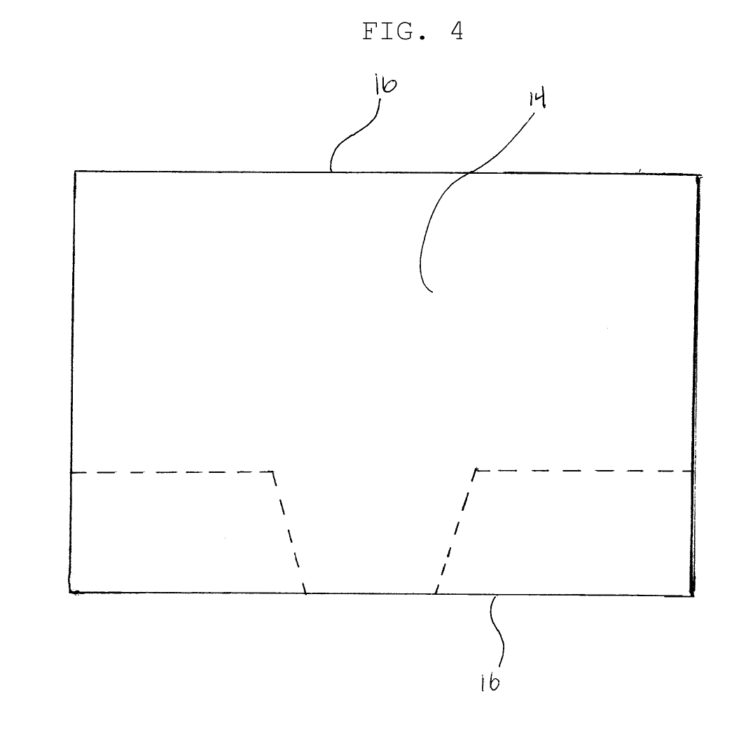

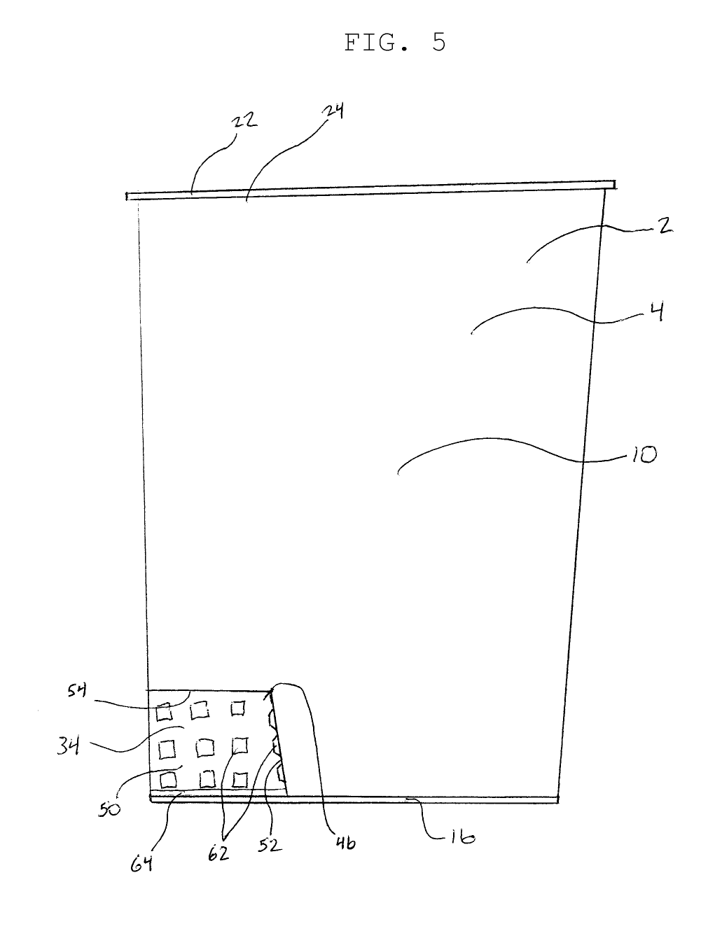

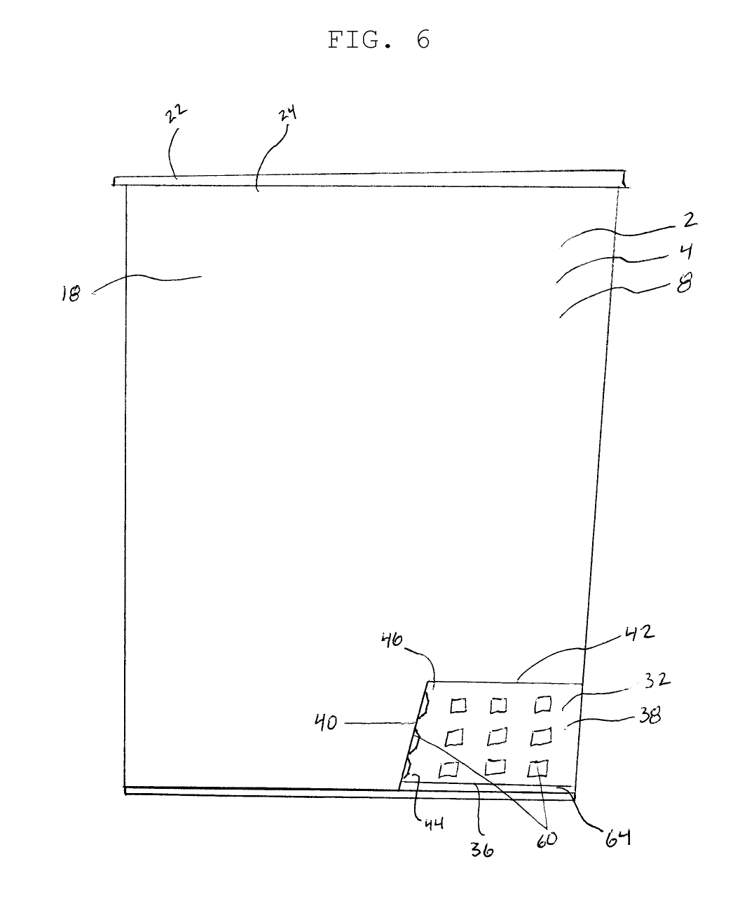

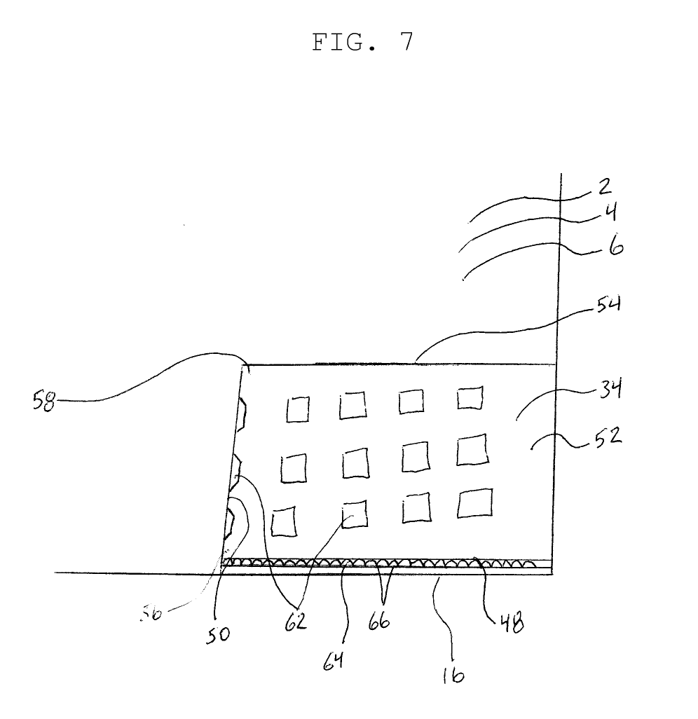

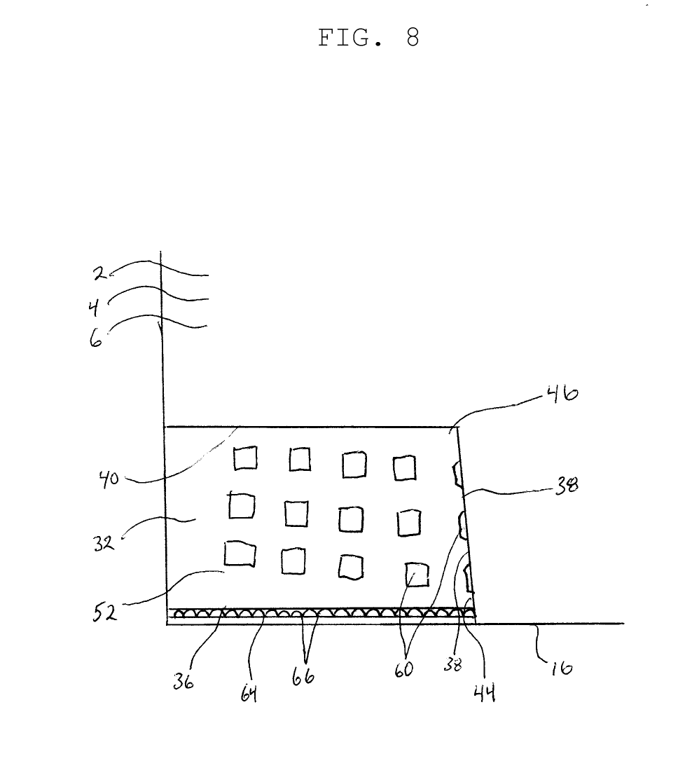

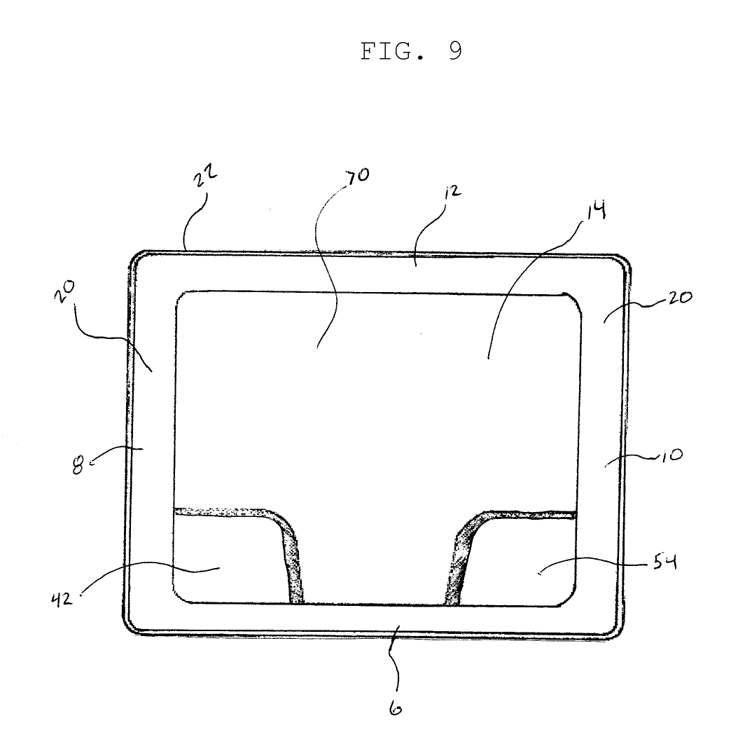

The present invention, shown in FIGS. 1-9, of the ergonomic vented waste container apparatus generally designated by the reference number 2 is described below.

Referring to FIGS. 1-9, the ergonomic vented waste container apparatus 2 is for use with trash liners. The apparatus 2 is made of mold injected plastic and is comprised of a continuous substantially vertical side wall 4 with front section of the side wall 6, a left section of the side wall 8, a right section of the side wall 10 and a rear section of the side wall 12. The shape of the apparatus 2 is generally rectangular or trapezoidal but the apparatus 2 is not limited to those shapes. The side wall 4 has a bottom edge 16 that is joined to a bottom surface 14 of the apparatus 2. The apparatus has an outer surface 18 of the side wall 4 and an inner surface 20 of the side wall 4. A lip 22 is located on an upper edge 24 of the side wall 4 with an opening 70 located at the top of the apparatus 2. The apparatus 2 has one or more vertical vents 26 located on the side wall 4 extending from a first position 28 that is proximal to the bottom edge 16 of the apparatus and extending upward to a second position 30 on the side wall 4. Optimal distance between the first position 28 and the second position 30 of the vertical vent 26 is six to twelve inches, but the vertical vent 26 is not limited to that length. The vertical vent 26 allows air to pass into the apparatus 2 thereby alleviating any vacuum that is created when a trash liner is lifted and allows air to flow an increased rate as the trash liner is lifted higher revealing more of the vertical vent 26. The apparatus 2 has a left foot well 32 and a right foot well 34 recessed into the interior of the apparatus 2. The left foot well 32 is located at the junction of the front surface 6 of the side wall, the left surface 8 of the side wall and the bottom edge 16 of the apparatus 2. The right foot well 34 is located at the junction of the front surface 6 of the side wall, the right surface 10 of the side wall and the bottom edge 16.

The left foot well 32 has a bottom foot surface 36, a right surface 38, a rear surface 40 and an upper surface 42, the upper surface 42 parallel to the bottom foot surface 36. An acute angle 40 is formed at the junction where the bottom foot surface 36 of the left foot well 32 meets the right surface 38 and an acute angle 40 is formed at the junction where the bottom foot surface 36 of the left foot well 32 meets the rear surface 40. An obtuse angle 46 is formed at the junction where the upper surface 42 of the left foot well 32 meets the right surface 38 of the left foot well 32 and obtuse angle 46 is formed at the junction where the upper surface 42 of the left foot well 32 meets the rear surface 40.

The right foot well 34 has a bottom foot surface 48, a left surface 50, a rear surface 52 and an upper surface 54, the upper surface 54 parallel to the bottom foot surface 48. An acute angle 56 is formed at the junction where the bottom foot surface 48 of the right foot well 34 meets the left surface 50 of the right foot well 34 and an acute angle 56 is formed at the junction where the bottom foot surface 48 of the right foot well 34 meets the rear surface 52 of the right foot well 34. An obtuse angle 58 is formed at the junction where the upper surface 54 of the right foot well 34 meets the left surface 50 of the right foot well 34 and an obtuse angle 58 is formed at the junction where the upper surface 54 of the right foot well 34 meets the rear surface 52 of the right foot well 34. The acute angle 44 and obtuse angle 46 of the left foot well 32 and acute angle 56 and obtuse angle 58 of the right foot well 34 promote quick nesting of an operator's foot.

The apparatus optionally includes a plurality of protruding knobs 60 that are formed and located on the right surface 38 and the rear surface 40 of the left foot well 32. A plurality of protruding knobs 62 are formed and located on the left surface 50 and the rear surface 52 of the right foot well 34. The protruding knobs 60 and 62 can be rectangular, circular, triangular or odd-shaped. The protruding knobs 60 and 62 can also be continuous manifestations that form ridges. The protruding knobs 60 and 62 allow for quick contact with the operator's foot and provide a location, in addition to the bottom foot surface 36 and bottom foot surface 48, for the foot to gain traction and stability while lifting a trash liner out of the apparatus 2.

The apparatus optionally includes traction pads 64 that are affixed to the bottom foot surface 36 of the left foot well 32 and to the bottom foot surface 48 of the right foot well 34. The traction pads 64 are ideally made of rubber and can have parallel ridges 66 that are diagonal 68. Additional materials that the traction pads could be formed from include sand paper, fabric, or carpet. The traction pads 64 in conjunction with the unique shape of the left foot well 32 and the right foot well 34 and the protruding knobs 60 and 62 work individually and in concert to stabilize, nest and trap an operator's foot in the left foot well 32 and the right foot well 34 to prevent injury.

While the invention has been shown and described in some detail with reference to specific exemplary embodiments, there is no intention that the invention be limited to such detail. On the contrary, the invention is intended to include any alternative or equivalent embodiments that fall within the spirit and scope of the invention as described herein.

What is claimed is:

1. An ergonomic vented waste container, comprising;
a container with a continuous substantially vertical side wall, the side wall having a front section, a left section, a right section, and a rear section;
a bottom surface attached to a bottom edge of the side wall forming said container, the container having an outer surface and an inner surface;
an open top in said container for inserting and removing a plastic trash liner into said container;
a lip located on the perimeter of an upper edge of the side wall;
one or more vertical vents situated on the continuous vertical side wall of the container extending from a first position above said bottom surface to a second position higher than said first position;
a left foot well situated at the bottom left corner of the front section of the side wall and a right foot well situated at the bottom right corner of the front section of the side wall, said left and right foot wells contiguous to the bottom edge of the side wall and the bottom surface;
said left foot well having a bottom foot surface, a right surface, a rear surface, and an upper surface, said right surface and rear surface of the left foot well forming an acute angle at their junction with the bottom foot surface of the left foot well, the upper surface positioned above and parallel to the bottom foot surface of the left foot well forming an obtuse angle with the right surface and the rear surface at their junction with the upper surface of the left foot well;
said right foot well having a bottom foot surface, a left surface, a rear surface and an upper surface, said left surface and rear surface of the right foot well forming an acute angle at their junction with the bottom foot surface of the right foot well, the upper surface positioned above and parallel to the bottom foot surface of the right foot well forming an obtuse angle with the left surface and the rear surface at their junction with the upper surface of the right foot well.

2. The waste container in claim 1, wherein the right surface and rear surface of the left foot well has a plurality of protruding knobs issuing outward for contact with an operators foot, and the left surface and rear surface of the right foot well has a plurality of protruding knobs issuing outward for contact with an operators foot.

3. The waste container in claim 2, wherein the distance between the first position and second position of each vertical vent is between 6 to 12 inches.

4. The waste container in claim 1, wherein the distance between the first position and second position of each vertical vent is between 6 to 12 inches.

5. The waste container in claim 4, wherein the left and right foot wells further comprise a traction pad affixed to the bottom foot surface of the left and right foot wells.

6. The waste container in claim 1, wherein the left and right foot wells further comprise a traction pad affixed to the bottom foot surface of the left and right foot wells.

7. The waste container in claim 6, wherein the traction pad is made of rubber.

8. The waste container in claim 7, wherein the traction pad has parallel ridges on its top surface.

9. The waste container in claim 8, wherein the parallel ridges on the traction pad are diagonal.

10. An ergonomic vented waste container, comprising;
a container with a continuous substantially vertical side wall, the side wall having a front section, a left section, a right section, and a rear section;
a bottom surface attached to a bottom edge of the side wall forming said container, the container having an outer surface and an inner surface;
an open top in said container for inserting and removing a plastic trash liner into said container;
a lip located on the perimeter of an upper edge of the side wall;
one or more vertical vents situated on the continuous vertical side wall of the container extending from a first position above said bottom surface to a second position higher than said first position;
a left foot well situated at the bottom left corner of the front section of the side wall and a right foot well situated at the bottom right corner of the front section of the side wall, said left and right foot wells contiguous to the bottom edge of the side wall and the bottom surface;
said left foot well having a bottom foot surface, a right surface, a rear surface, and an upper surface, said right surface and rear surface of the left foot well forming an acute angle at their junction with the bottom foot surface of the left foot well, the upper surface positioned above and parallel to the bottom foot surface of the left foot well forming an obtuse angle with the right surface and the rear surface at their junction with the upper surface of the left foot well;
said right foot well having a bottom foot surface, a left surface, a rear surface and an upper surface, said left surface and rear surface of the right foot well forming an acute angle at their junction with the bottom foot surface of the right foot well, the upper surface positioned above and parallel to the bottom foot surface of the right foot well forming an obtuse angle with the left surface and the rear surface at their junction with the upper surface of the right foot well.

11. The waste container in claim 10, wherein the left and right foot wells further comprise a traction pad affixed to the bottom foot surface of the left and right foot wells.

12. The waste container in claim 11, wherein the traction pad is made of rubber.

13. The waste container in claim 12, wherein the traction pad has parallel ridges on its top surface.

14. The waste container in claim 13, wherein the parallel ridges on the traction pad are diagonal.

15. The waste container in claim 14, wherein the right surface and rear surface of the left foot well has a plurality of protruding knobs issuing outward for contact with an operators foot, and the left surface and rear surface of the right foot well has a plurality of protruding knobs issuing outward for contact with an operators foot.

16. The waste container in claim 15, wherein the distance between the first position and second position of each vertical vent is between 6 to 12 inches.

17. The waste container in claim 16, wherein the upper edge of the side wall has a larger circumference than the circumference of the bottom edge of the side wall.

18. The waste container in claim 11, wherein the right surface and rear surface of the left foot well has a plurality of protruding knobs issuing outward for contact with an operators foot, and the left surface and rear surface of the right foot well has a plurality of protruding knobs issuing outward for contact with an operators foot.
